(19) United States
(12) Patent Application Publication
(10) Pub. No.: US 2021/0120777 A1
(43) Pub. Date: Apr. 29, 2021

(54) ELECTRIC HEATING MAT SYSTEM

(71) Applicant: JR Bighorn Gustafson, Anchorage, AK (US)

(72) Inventor: JR Bighorn Gustafson, Anchorage, AK (US)

(21) Appl. No.: 16/663,666

(22) Filed: Oct. 25, 2019

(51) Int. Cl. A01K 1/015; A01K 1/035; H05B 3/34; H05B 3/36

(52) U.S. Cl. CPC A01K 1/0158; A01K 1/0353; H05B 2203/017; H05B 3/36; H05B 2203/014; H05B 3/342

(57) ABSTRACT

An electric heating mat system including at least two layers of heat conductive material forming a mat, electrical wiring positioned between the layers of heat conductive material, a thermostat and thermostat-gauge for maintaining and controlling a temperature of the electrical heating system, a fastening assembly including at least one tie-strap and a receiving-member, and a power cord. The electrical wiring generates heat via passing electric current through the electrical wiring to spread the heat through the at least two layers of the heat conductive material to provide a heated surface. The mat provides a heated, sanitary sleeping area for animals.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of pet mats and more specifically relates to heated pet mats.

### 2. Description of Related Art

Animals are an important part of our society. Many animals are domestic pets. It is common for dogs and other pets to spend all or part of the day outside even during the winter. When the temperature outside is cold, the dog may require supplemental heat to maintain its body temperature. It is important to protect these animals against harsh weather which may sometimes prove fatal. Many pads and beds harbor bugs and mosquitoes which carry diseases and also when the bugs enter inside the pads they can lay eggs can causing discomfort to the pet by biting them. A suitable alternative is desired.

U.S. Pat. No. 7,755,007 to James Donald Koskey, Jr. relates to a heated pet mat. The described heated pet mat includes a heated pet mat which has a fire retardant covering in the shape of a truncated circle folded in half to form two layers. A resistive heating element is sandwiched between the two layers.

### BRIEF SUMMARY OF THE INVENTION

In view of the foregoing disadvantages inherent in the known pet mat art, the present disclosure provides a novel electric heating mat system. The general purpose of the present disclosure, which will be described subsequently in greater detail, is to provide an electrical heating system for providing sanitary and comfortable heating to animals.

An electric heating mat system is disclosed herein. The electric heating mat system includes at least two layers of heat conductive material forming a mat, electrical wiring positioned between the layers of heat conductive material, a thermostat and thermostat-gauge for maintaining and controlling a temperature of the electrical heating system, a fastening assembly including two tie-straps and two receiving-members, and a power cord. The power cord extends out of the electrical heating system and is configured to connect to a power source such as an AC wall socket. The power cord extending from the electrical heating system is preferably covered or otherwise coated with a plastic-layer. The electrical wiring generates heat via passing electric current through the electrical wiring to spread the heat through the at least two layers of the heat conductive material to provide a heated surface. The electrical heating system is configured to be folded and securable in a rolled-condition via the fastening assembly including the at least one tie-strap and the receiving-member.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an electric heating mat system, constructed and operative according to the teachings of the present disclosure.

FIG. 1 is a perspective view of the electric heating mat system during an ‘in-use’ condition, according to an embodiment of the disclosure.

FIG. 2 is a perspective view of the electric heating mat system of FIG. 1, according to an embodiment of the present disclosure.

FIG. 3 is a perspective view of the electric heating mat system of FIG. 1, according to an embodiment of the present disclosure.

FIG. 4 is a perspective view of the electric heating mat system of FIG. 1, according to an embodiment of the present disclosure.

FIG. 5 is a top view of the electric heating mat system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a pet mat and more particularly to an electric heating mat system as used to improve electrical heating systems for animals and humans.

Generally, the electrical heating system comprises an electrical wire sandwiched between two layers of electrically insulating, heat conductive material and a thermostat for providing safe, sanitary and comfortable heat to animals. The wiring is present throughout the layers of the electrically insulating, heat conductive material. The wiring is preferably configured in a circular (round pattern). However, the electrical wiring may be present throughout the layers of the electrically insulating, heat conductive material in any suitable pattern. In a preferred embodiment, the electrical wiring is present in the middle of the electrical heating system. The electrical wiring extends out of the electrical heating system and connects to a power source such as a wall-socket. When the power source is switched on to run the current through the electrical wiring present inside the electrical heating system, the electrical wiring generates heat due to its resistance. The heat generated in the electrical wiring is spread (radiated) throughout the layers of the electrically insulating, heat conductive material. The electrically insulating, heat conductive material due to its properties does not allow electric current to reach the top and bottom surfaces of the electrical heating system, thereby preventing any event of electrocution. Furthermore, the material allows the heat generated by the electrical wiring to reach the surface of the electrical heating material, thereby providing safe and comfortable heat to animals.

The electric wiring of the electrical heating system is configured to transfer temperature only to a predetermined temperature above a normal temperature which is comfortable to the animal. The thermostat allows a user to set a predetermined required comfortable temperature according to the need of the animal using the electrical heating system. The thermostat in the electrical heating system maintains a desired temperature by monitoring the temperature in the electrical heating system. Activation and deactivation of the electrical heating system is controlled via the thermostat based on the temperature sensed to prevent discomfort due to potentially harmful high range of temperature.

The electrical heating system may include at least one handle. The at least one handle may be present at one side of the electrical heating system. The handle may be used to hang the electrical heating system out of the way when it is not in use to provide convenient storage. The handle is strong to support the weight of the electrical heating system. In one of the preferred embodiments of the present invention, the handle can be used fasten the electrical heating system in its position so that animal cannot move the mat out of the position.

The electrically insulating, heat conductive material is present in layers in the electrical heating system which is preferably made up of, but not limited to, rubber or foam. In one aspect of the present invention, out of the two layers of the electrical heating system, the lower layer of the electrically insulating material is nonconductive to heat. The material is soft and provides cushion to the animal thereby preventing any hard shock to bones or joints, broken bones or injuries to body parts. In a preferred embodiment, the electrical heating system comprises two layers of the electrically insulating, heat conductive material joined together by electronic wielding. The electronic wielding joins the two layers without leaving any gap such that bugs and other insects such as mosquitoes cannot enter inside the electrical heating system.

The electrical heating system may be provided in various forms. It may be a doorway entrance mat or a mat for an animal or human to sleep comfortably at a warm body temperature. The doorway entrance mat embodiment is heated such that it prevents ice and snow buildup. In one embodiment, the electrical heating system includes a human electrical blanket form. In the human electrical blanket embodiment, a power cord is provided extending from the mat and configured to connect to a 220 volts socket. Furthermore, the thermostat may be connected to the power cord to regulate the temperature provided to the animal or human.

The electrical heating system is intended to be recycled. The electrical heating system may be dismantled to remove wiring, thermostat and the electrically insulating, heat conductive material to recycle components. Hence the electrical heating system is environmentally safe. The electrical heating system can be developed in different sizes for different use. It can be used for animals as well as humans. The electrical heating system is intended for use by newborn, pre-term infant, an infant, a child, a teenager and an adult. The electrical heating system is intended to be provided in sizes such that it may cover a whole area of an animal or human.

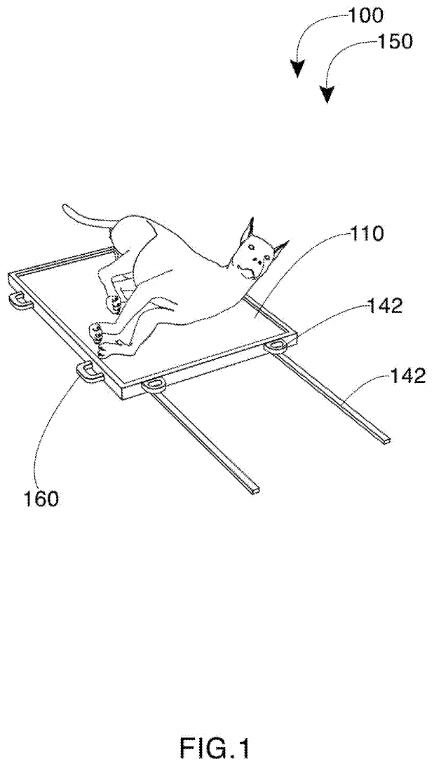

Referring now more specifically to the drawings by numerals of reference, there is shown in FIGS. 1-5, various views of an electric heating mat system 100. FIG. 1 shows an electric heating mat system 100 during an ‘in-use’ condition 150, according to an embodiment of the present disclosure. As illustrated, the electric heating mat system 100 may include at least two layers of heat conductive material forming a mat 110, electrical wiring 120 positioned between the layers of heat conductive material, a thermostat 126 and thermostat-gauge 130 for maintaining and controlling a temperature of the electrical heating system 100, a fastening assembly 140 including at least one tie-strap 142 and a receiving-member 144, and a power cord 148. The electrical wiring 120 generates heat via passing electric current through the electrical wiring 120 to spread the heat through the at least two layers of the heat conductive material to provide a heated surface.

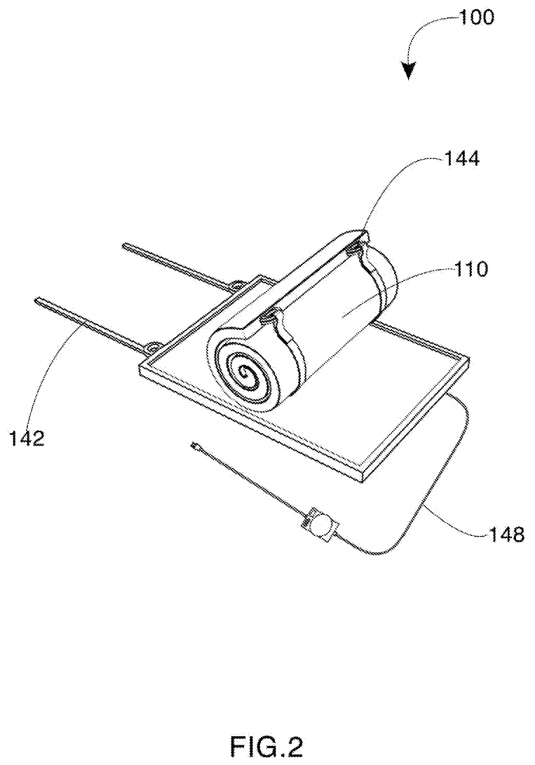

FIG. 2 shows a perspective view of the electric heating mat system 100 of FIG. 1, according to an embodiment of the present disclosure. As above, the electric heating mat system 100 may include the mat 110 comprising at least two layers of heat conductive material. As shown in FIG. 2, the mat 110 featuring the fastening assembly 140 including at least one tie-strap 142 and a mating receiving-member 144. In a preferred embodiment, the fastening assembly 140 comprises two tie-straps 142 and two receiving-members 144 configured to mate with their respective parts. The electrical heating system 100 is configured to be folded and securable in a rolled-condition via the fastening assembly 140 including the at least one tie-strap 142 and the receiving-member 144. The electrical heating system 100 may further comprise at least one handle 160.

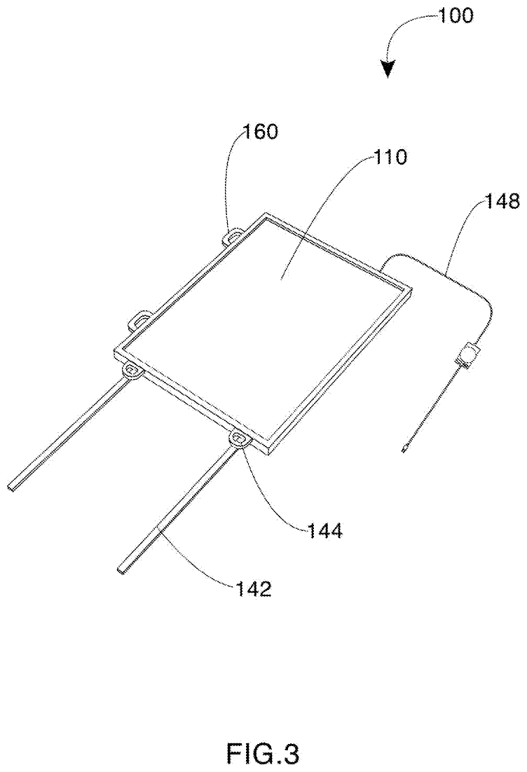

FIG. 3 shows a perspective view of the electric heating mat system 100 of FIG. 1, according to an embodiment of the present disclosure. As above, the electric heating mat system 100 may include the at least two layers of heat conductive material forming the mat 110, electrical wiring 120 positioned between the layers of heat conductive material, the thermostat 126 and thermostat-gauge 130, the fastening assembly 140, and the power cord 148. The heat conductive material is effectively non-flammable. The heat conductive material may include rubber, foam, and/or other suitable materials. In certain embodiments, the electrical wiring 120 may be present throughout the layers of the heat conductive material. The electrical wiring 120 may be present in a middle layer of the electrical heating system 100. Further, the electrical wiring 120 may be configured in a circular configuration. The mat 110 may include a human electrical blanket, a mat provided for a door entrance, or a sleeping-mat for animals.

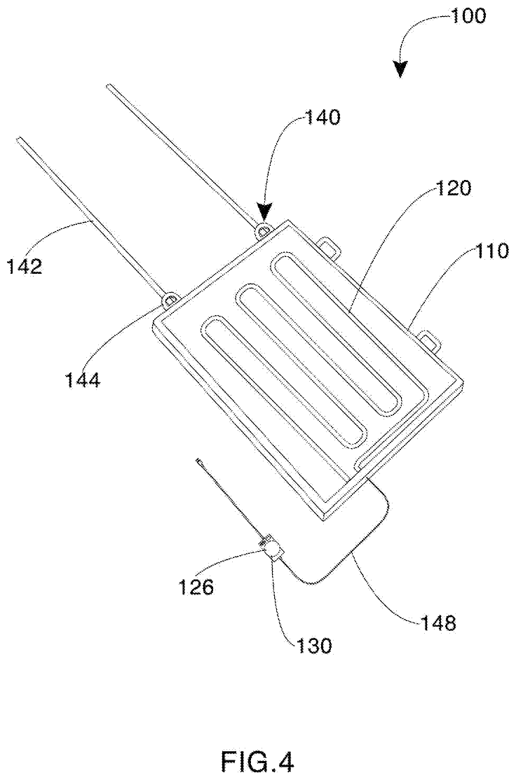

FIG. 4 shows a perspective view of the electric heating mat system 100 of FIG. 1, according to an embodiment of the present disclosure. As above, the electric heating mat system 100 may include the mat 110 having a cushion surface providing a heated sleeping-mat for animals. As shown in FIG. 4, the power cord 148 extends out of the mat 110 of the electrical heating system 100 and is configured to connect to a power source such as an AC wall socket. The power cord 148 extending from the electrical heating system 100 is preferably covered or otherwise coated with a plastic-layer. The thermostat 126 and thermostat-gauge 130 are connected to the power cord 148 and may be manipulated by a user. The thermostat 126 is configured to monitor the temperature and activate and deactivate the electrical heating system 100 according to the temperature. The temperature may be pre-determined.

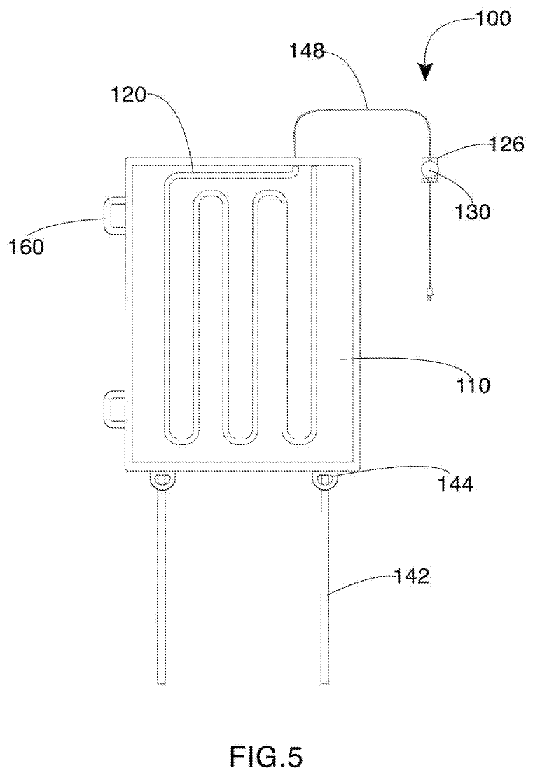

FIG. 5 shows a perspective view of the electric heating mat system 100 of FIG. 1, according to an embodiment of the present disclosure. As above, the electric heating mat system 100 may include the mat 110 comprising at least two layers of the heat conductive material. In a preferred embodiment, the at least two layers of the heat conductive material are joined together by electronic welding. The electronic wielding joins the two layers without leaving a gap such that bugs and other insects such as mosquitoes cannot enter inside the electrical heating system.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An electric heating mat system comprising:
at least two layers of heat conductive material forming a mat;
electrical wiring positioned between said layers of heat conductive material, wherein said electrical wiring generates heat via passing electric current through said electrical wiring to spread said heat through said at least two layers of said heat conductive material;
a thermostat and thermostat-gauge for maintaining and controlling a temperature of said electrical heating system;
a fastening assembly including at least one tie-strap and a receiving-member; and
a power cord.

2. The electric heating mat system of claim 1, wherein said electrical wiring is present throughout said layers of said heat conductive material.

3. The electric heating mat system of claim 1, wherein said electrical wiring is configured in a circular configuration.

4. The electric heating mat system of claim 1, wherein said electrical wiring is present in a middle layer of the electrical heating system.

5. The electric heating mat system of claim 1, wherein said power cord extends out of the electrical heating system and is configured to connect to a power source.

6. The electric heating mat system of claim 5, wherein said power source is an AC wall socket.

7. The electric heating mat system of claim 5, wherein said power cord extending from said electrical heating system is covered with a plastic-layer.

8. The electric heating mat system of claim 1, wherein said fastening assembly comprises two tie-straps and two receiving-members.

9. The electric heating mat system of claim 1, wherein said electrical heating system further comprises at least one handle.

10. The electric heating mat system of claim 1, wherein said heat conductive material is effectively non-flammable.

11. The electric heating mat system of claim 10, wherein said heat conductive material is selected from the group consisting of rubber and foam.

12. The electric heating mat system of claim 1, wherein said mat is provided as a sleeping-mat.

13. The electric heating mat system of claim 1, wherein said mat is provided for a door entrance.

14. The electric heating mat system of claim 1, wherein said mat is provided as a human electrical blanket.

15. The electric heating mat system of claim 1, wherein said at least two layers of the heat conductive material are joined together by electronic welding.

16. The electric heating mat system of claim 1, wherein said mat comprises a cushion surface.

17. The electric heating mat system of claim 1, wherein said thermostat is configured to monitor said temperature and activate and deactivate said electrical heating system according to said temperature.

18. The electric heating mat system of claim 17, wherein said temperature is pre-determined.

19. The electric heating mat system of claim 1, wherein said electrical heating system is configured to be folded and securable in a rolled-condition via said fastening assembly including said at least one tie-strap and said receiving-member.

20. An electric heating mat system, the electric heating mat system comprising:
at least two layers of heat conductive material forming a mat;
electrical wiring positioned between said layers of heat conductive material, wherein said electrical wiring generates heat via passing electric current through said electrical wiring to spread said heat through said at least two layers of said heat conductive material;
a thermostat and thermostat-gauge for maintaining and controlling a temperature of said electrical heating system;
a fastening assembly including at least one tie-strap and a receiving-member; and
a power cord;
wherein said power cord extends out of the electrical heating system and is configured to connect to a power source;
wherein said power source is an AC wall socket;
wherein said power cord extending from said electrical heating system is covered with a plastic-layer;
wherein said fastening assembly comprises two tie-straps and two receiving-members;
wherein said electrical heating system further comprises at least one handle;
wherein said heat conductive material is effectively non-flammable;
wherein said heat conductive material is selected from the group consisting of rubber and foam;
wherein said mat is provided as a sleeping-mat for an animal;
wherein said at least two layers of the heat conductive material are joined together by electronic welding;
wherein said mat comprises a cushion surface;
wherein said thermostat is configured to monitor said temperature and activate and deactivate said electrical heating system according to said temperature; and
wherein said electrical heating system is configured to be folded and securable in a rolled-condition via said fastening assembly including said at least one tie-strap and said receiving-member.
